(19) United States
(12) Patent Application Publication
(10) Pub. No.: US 2007/0082164 A1
(43) Pub. Date: Apr. 12, 2007

(54) MAT FOR HEATED ITEMS WITH CUTTING INDICIA

(76) Inventor: Jenna Sellers, Delray Beach, FL (US)

Correspondence Address: MALIN HALEY AND DIMAGGIO, PA, 1936 S ANDREWS AVENUE, FORT LAUDERDALE, FL, 33316, US

(21) Appl. No.: 11/163,241

(22) Filed: Oct. 11, 2005

(51) Int. Cl. G09F 3/00

(52) U.S. Cl. 428/43; 428/167

(57) ABSTRACT

A multi-purpose, heat-resistant mat that comprises a single, flexible, thin body of elastomer material, which is preferably silicone, to provide thermal insulation. The solid planar body of elastomer material of the mat further includes numerous indicia providing grooves that score the bottom surface of the elastomer material for indicia aligned visual reference to permit cutting the original mat to a smaller size for custom fitting a particular pan or bowl. The mat may be cut linearly along one or more grooves to reduce the mat to a shape and size desired by the user. The mat also acts to cushion heated dishes and breakable cookware on hard surfaces so as to prevent damage to or breakage of the dishes against the hard surface while protecting the countertop surface from burning, scorching, and other physical abrasions.

### FIELD OF THE INVENTION

This invention relates to a multi-purpose mat for the kitchen for supporting, insulating and cushioning heated items such as dishes and pans. The mat has visual indicia in the form of linear grooves for ease in cutting to a custom size for use on a table or countertop.

### DESCRIPTION OF RELATED ART

In home kitchens, pots and pans must often be removed from an oven or stove to allow for cooling of the food or to make room for other pots or pans of food to be cooked on the appliances. Pots, pans, dishes, and other cookware and objects are often heated to temperatures high enough to cause burning and scorching to a countertop, table, or other surface upon which the heated object is placed. The usage of traditional cloth “pot holders” for protecting countertop and table surfaces from damage caused by the heated pots and pans is not effective primarily for several reasons. First, the cloth pot holder may itself be damaged by burning or scorching of the material through prolonged exposure to extreme and concentrated heat that radiates from the bottom of a heated pan or pot. Second, conventional cloth pot holders are not easily cleaned and may become stained through contact with various food preparations that splash or spill onto said pot holder. Pads or mats constructed from heat-resistant materials, such as silicone, can prevent heat-related damage to countertop and table surfaces, while also eliminating physical abrasions caused by the placement of cookware and dishes on smooth surfaces. Moreover, heat-resistant elastomer materials, like silicone, are easily washed after cooling and are not easily stained by contact with food preparations.

Silicone is an effective material for preventing heat damage caused by heated pots and pans because silicone is a poor conductor of thermal energy. The insulating properties of silicone make the chemical an excellent material for the manufacture of heat pads and mats that are used in both home and commercial kitchens. Silicone mats are also easy to care for and may be quickly rinsed and washed clean of splashed and spilled food materials. Silicone may also be molded during manufacturing into virtually any desired shape and can be produced in types with varying resistances to heat exposure.

### SUMMARY OF THE INVENTION

The applicant's invention relates to a multi-purpose mat for supporting and insulating heated items such as pots, pans, casserole dishes and bowls to prevent heat damage to the support surface upon which the heated item is placed. The mat also cushions the pot or pan when rested upon a table or countertop surface. The mat comprises a single, flexible, thin solid body of silicone or other elastomer material having both a top and bottom surface. The bottom surface of the mat is mostly smooth but includes numerous horizontal and vertical straight line grooves that intersect perpendicularly. The mat bottom grooves provide indicia alignment visual reference for cutting the mat into a desired shape and size for specific pots or pans. This allows for a custom-made size mat for a countertop.

Preferably, silicone is the elastomer material from which the mat is constructed so that said mat can be used in hot water and under high temperature conditions, however, the mat may also be constructed from other suitable, heat-resistant materials that are flexible or rubber-like. The elastomer material used for construction of the mat must be heat-resistant at temperatures up to or greater than 600 degrees Fahrenheit.

The mat can be custom cut manually to a size and shape desired by the user so as to fit the user's requirements, such as for fitting under a pot or pan or for use as a place mat. The thermal protecting mat is customized by cutting through the thinner vertical and horizontal grooves on the bottom side of said mat, which are arranged linearly, for visual alignment during cutting thereby preserving the aesthetic appeal of the mat while allowing said mat to be reduced to a preferred size and shape. Stated differently, the grooves are straight lines and provide a straight line reference for cutting with scissors or another cutting implement to achieve a straight side of a desired size.

The mat can be placed under heated dishes, pots, pans, mugs, and any other heated cookware or object for which the user requires cushioning to prevent denting or breaking of the dish or other abrasions to the supporting surface while said object is being used by an individual as well as where the user requires protection for the surface, such as a countertop, from the heated object. The thick elastomer material of said mat provides protection from heat damage to a countertop, table, or other surface by preventing physical contact with said countertop or other surface.

An object of this invention is to provide a heat pad for protecting countertops, tables, and other surfaces from burning or scorching that could occur when a heated pan, pot, or other object is placed upon said countertop or other surface.

Another object of this invention is to provide a pad or mat for heated items that is easily cut to customize said mat to the size and shape desired by the user.

Still another object of this invention is to provide a mat for heated items that is resistant to high temperatures associated with heated cookware and dishes and that protects countertops, tables, and other surfaces from physical abrasions.

In accordance with these and other objects which will become apparent hereinafter, the instant invention will now be described with particular reference to the accompanying drawings.

### BRIEF DESCRIPTION OF THE DRAWINGS

FIG. 1 shows a perspective view of a multi-purpose mat having a plurality of grooves molded into one surface, wherein the top and bottom surfaces of said mat are identical except with respect to the placement of the grooves on one of said surfaces and not on the other surface.

FIG. 2 shows a plan view of the multi-purpose mat having a plurality of grooves molded into one surface, wherein the top and bottom surfaces of said mat are identical except with respect to the placement of the grooves on one of said surfaces and not on the other surface.

FIG. 3 shows a side elevational view in cross-section of the multi-purpose mat having a plurality of grooves molded into one surface, wherein the top and bottom surfaces of said mat are identical except with respect to the placement of the grooves on one of said surfaces and not on the other surface.

FIG. 4A shows a side elevational view in cross-section of an alternate embodiment of the invention having parallel and opposite grooves molded into both the top and bottom surfaces of the mat.

FIG. 4B shows a side elevational view in cross-section of an alternate embodiment of the invention having non-parallel grooves that are opposite and alternating molded into the top and bottom surfaces of the mat.

### DETAILED DESCRIPTION

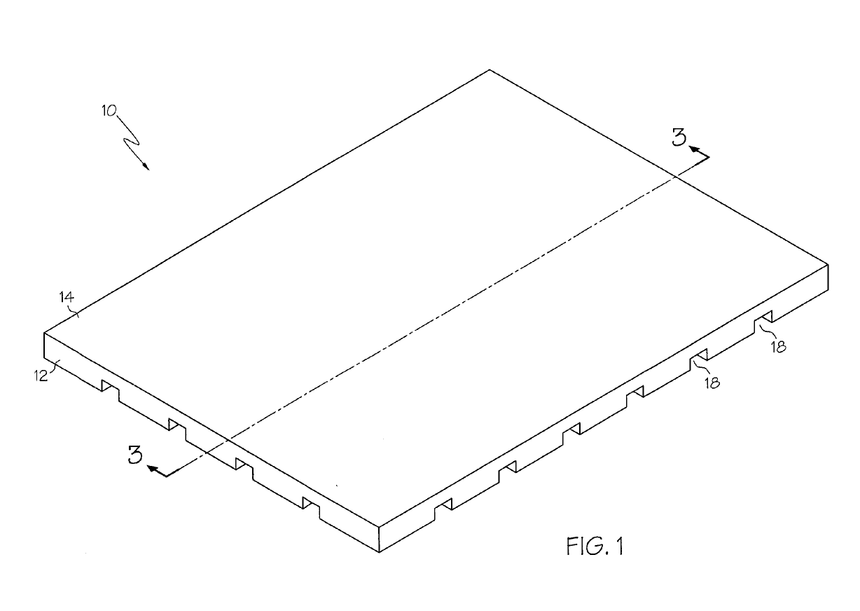

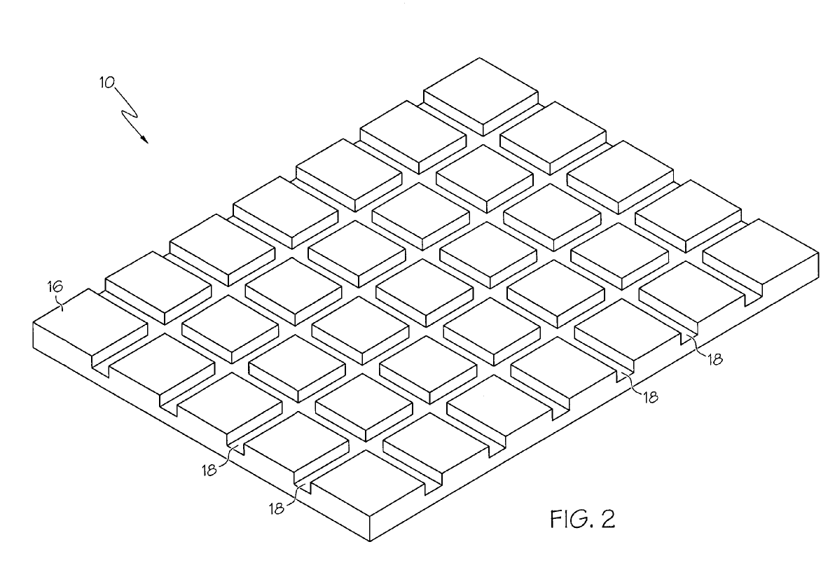

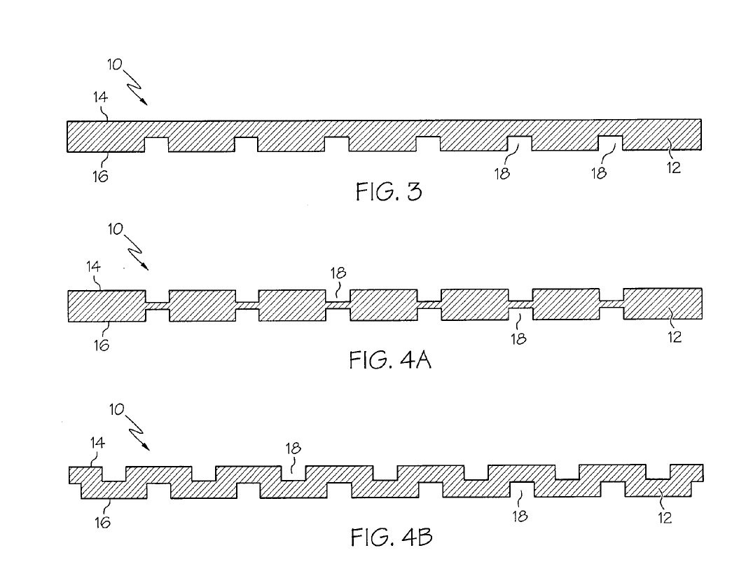

FIGS. 1 and 2 illustrate a multi-purpose mat 10 for placing under heated items to prevent heat damage to a surface upon which the heated item is rested. The mat 10 comprises a single, flexible, thin solid body of silicone material 12 primarily to thermally insulate and secondarily to cushion objects rested upon table or countertop surfaces. The mat is approximately one-half inch thick but could vary. The mat 10 further comprises a planar top surface 14 and a planar bottom surface 16. FIGS. 2 and 3 illustrate the bottom surface 16 of said mat 10, which is mostly smooth but also includes numerous straight horizontal and vertical grooves 18 that intersect perpendicularly on the bottom surface 16 of the silicone material 12 of said mat 10. Heated items are placed upon the top surface 14 of the mat 10, while the bottom surface 16 of said mat 10 rests upon the countertop or table, thereby providing a protective buffer between the heated object and the table or countertop surface.

Preferably, the material 12 from which the mat 10 is constructed is silicone so that said mat 10 can be used in hot water and under high temperature conditions. However, said mat 10 may also be constructed from other suitable thermal-insulating materials that are flexible or rubber-like. The silicone material 12 used for construction of the mat 10 is heat resistant at temperatures up to 600 degrees Fahrenheit. This temperature limit is high enough to ensure that heated cookware and other items in a home kitchen will not burn through or melt the mat or cause damage to the countertop surface.

The mat 10 can be cut with straight sides to a size and shape desired by the user so as to fit the user's requirements, such as for fitting under a pot or pan or for use as a place mat. Said mat 10 is customized by cutting through the thinner straight vertical and straight horizontal grooves 18 of said mat, which are arranged linearly, thereby preserving the aesthetic appeal of the mat 10 while allowing said mat to be reduced to a preferred size and shape. The mat bottom grooves provide a visual reference for cutting or tearing a straight line. The grooves 18 in the bottom surface 16 of the mat 10 form lines of separation that indicate potential points for cutting the mat so that said mat 10 can be customized in the shape and size required by the user. In one embodiment, the grooves 18 include starting perforations to aid the user in more easily beginning to cut through said grooves 18.

While, thus far, the grooves 18 have been described as being located on the bottom surface 16 of the mat 10, the top surface 14 and said bottom surface 16 of the mat 10 are substantially identical other than the location of the placement of the grooves 18 on one of the surfaces as opposed to the other surface. Therefore, said grooves 18 may be located on the top surface 14 of the mat rather than said bottom surface 16; however, the appearance of the mat 10 having grooves 18 located on the top surface is identical to said mat with grooves located on the bottom surface, as shown in FIGS. 2 and 3.

In another embodiment of the invention, both the top surface 14 and the bottom surface 16 of said mat 10 include parallel, corresponding, opposing grooves 18 such that each groove of the top surface runs directly above and parallel to an opposing, corresponding groove on the bottom surface of the mat. FIG. 4A illustrates this embodiment of the invention.

FIG. 4B illustrates still another embodiment of the invention. In this embodiment, said grooves 18 of the top and bottom surface 14 and 16 of the mat 10 are not parallel and opposing. Therefore, the grooves 18 of the top surface 14 are not aligned in parallel so as to be opposite and corresponding to the grooves 18 of the bottom surface 16, but rather, the grooves of the top surface are opposite and alternating in relation to the grooves of the bottom surface. The opposite and alternating grooves 18 of the top surface 14 and bottom surface 16 of the mat 10 in this embodiment give the mat an appearance in a cross-sectional view of being corrugated as shown in FIG. 4B.

The mat 10 is resilient and acts as a cushion to prevent breakage of glass objects placed on a rigid tile or ceramic surface. The mat 10 can be placed under heated dishes, pots, pans, mugs, and any other heated cookware or object for which the user requires cushioning to prevent denting or other abrasions to the table or countertop surface while said object is being used by an individual as well as where the user requires protection for the surface, such as a countertop, from the heated object. The thick elastomer material 12 of said mat 10 also provides cushioning and protection from heat damage to a countertop, table, or other surface by preventing physical contact with said countertop or other surface that otherwise might produce burning, scorching, discoloring, denting, scuffing, scratching, and other physical abrasions to said surface. The thermal insulation properties of the mat 10 prevent the conduction of heat from the heated pot or pan to the countertop surface, thereby preventing burning or scorching of said surface.

The thickness of the mat can be varied as long as sufficient thermal insulation is provided for heated objects having a temperature of 600 degrees Fahrenheit or less. The mat is also safe for use inside dishwashers and freezers.

In an alternate embodiment of the invention, rather than being comprised of one solid body, the mat 10 is comprised of interconnected elastomer squares or disks and adjoining strips of elastomer material, which together form a matrix of apertures present between said squares and said strips of interconnected elastomer material. These apertures allow water to drain through the mat 10. In another embodiment, the mat 10 may be constructed from squares having several different area sizes or disks having several different diameters interconnected at various angles by strips of interconnecting elastomer material.

The mat 10 may include a corner elastomer disk having an attached annular tab connected to said corner disk by a strip of interconnecting elastomer material, said annular tab including a central aperture for receiving a hook so that the mat 10 may be hung for drying after use.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A multi-purpose mat for placing under heated items to prevent denting and other abrasions as well as heat damage to a surface upon which the heated item is rested, comprising:
a single, flexible, thin solid body of elastomer material having a top surface and a bottom surface to provide thermal insulation of heated objects, said body of elastomer material further comprising a plurality of grooves that act as indicia for aligning a cutting device on one or more surfaces of said elastomer material for visual reference for cutting straight lines.

2. The mat of claim 1, wherein said bottom surface is scored by the plurality of grooves, said grooves being oriented preferably vertically and horizontally.

3. The mat of claim 1, wherein said top surface is scored by the plurality of grooves, said grooves being oriented preferably vertically and horizontally.

4. The mat of claim 1, wherein both the top surface and the bottom surface of said mat are scored by the plurality of grooves, said grooves being oriented preferably vertically and horizontally.

5. The mat of claim 4, wherein both the top surface and the bottom surface of said mat are scored by the plurality of grooves;
wherein said grooves on each of the top and bottom surfaces are parallel, corresponding, and opposing such that each groove of the top surface runs directly above and parallel to an opposing, corresponding groove on the bottom surface of the mat.

6. The mat of claim 4, wherein both the top surface and the bottom surface of said mat are scored by the plurality of grooves;
wherein the grooves of the top surface are not aligned in parallel so as to be opposite and corresponding to the grooves of the bottom surface, but rather, are opposite and alternating so as not to be parallel, thereby giving the mat a corrugated appearance when viewed in cross-section.

7. The mat of claim 2, wherein said plurality of grooves that score the bottom surface of the mat comprise a plurality of perpendicularly-intersecting horizontal and vertical grooves.

8. The mat of claim 1, wherein the elastomer material used for construction of the mat is heat resistant at temperatures up to 600 degrees Fahrenheit.

9. The mat of claim 1, wherein the elastomer material used to construct the mat is preferably silicone so that said mat can be used in hot water and under high temperature conditions.

10. The mat of claim 9 wherein the type of silicone used for construction of the mat is heat-resistant at temperatures up to 600 degrees Fahrenheit.

11. The mat of claim 1, wherein said mat is constructed from a thermally insulating material that is resilient.

12. The mat of claim 1, wherein said mat can be cut to a size and shape desired by the user so as to fit the user's requirements, such as for fitting under a pot or pan or for use as a place mat, by cutting through the thinner grooves of said mat, which are arranged linearly, thereby preserving the aesthetic appeal of the mat while allowing said mat to be reduced to a preferred size and shape.

13. The mat of claim 1, wherein said mat can be placed under heated dishes, pots, pans, mugs, and any other heated cookware or object for which the user requires cushioning to prevent denting and other abrasions to the table or countertop surface while said object is being used by an individual as well as where the user requires protection for the surface, such as a countertop, from the heated object.

14. The mat of claim 1, wherein the thick elastomer material of said mat provides cushioning protection to a countertop, table, or other surface by preventing physical contact with said countertop or other surface that otherwise may produce denting, scuffing, scratching, and other physical abrasions to said surface.

15. The mat of claim 1, wherein the thick elastomer material of said mat provides protection from heat damage to a countertop, table, or other surface by thermal insulation to prevent heat conduction to said countertop or other surface that can produce burning, scorching, or discoloring to said surface.

16. The mat of claim 1, wherein the plurality of grooves on the bottom surface of the mat form lines of separation that indicate potential points for cutting the mat so that said mat can be customized in the shape and size required by the user.

17. The mat of claim 1, wherein said mat is safe for use in dishwashers and freezers.

18. A multi-purpose mat for placing under heated items to prevent denting and other abrasions as well as for preventing heat damage to a surface upon which the heated item is rested as illustrated in FIGS. 1 through 3.

19. A multi-purpose mat for placing under heated items to prevent denting and other abrasions as well as for preventing heat damage to a surface upon which the heated item is rested as illustrated in FIG. 4A.

20. A multi-purpose mat for placing under heated items to prevent denting and other abrasions as well as for preventing heat damage to a surface upon which the heated item is rested as illustrated in FIG. 4B.
